(19) United States
(12) Patent Application Publication
(10) Pub. No.: US 2016/0061293 A1
(43) Pub. Date: Mar. 3, 2016

(54) Integrated Transmission System and Method Thereof

(71) Applicant: National Sun Yat-Sen University, Kaohsiung (TW)

(72) Inventors: Guan-Shyong Hwang, Kaohsiung (TW); Der-Min Tsay, Kaohsiung (TW); Bor-Jeng Lin, Kaohsiung (TW); Jao-Hwa Kuang, Kaohsiung (TW)

(21) Appl. No.: 14/606,128

(22) Filed: Jan. 27, 2015

(30) Foreign Application Priority Data
Jan. 20, 2014 (TW) 103101947

(51) Int. Cl. F16H 3/00; B60K 6/36; B62M 6/40; F16H 61/02; F16H 3/72; F16H 3/66

(52) U.S. Cl. CPC F16H 3/006; F16H 3/724; F16H 3/66; B62M 6/40; F16H 61/0202; B60K 6/36; Y10S 903/909

(57) ABSTRACT

An integrated transmission system includes a controllably integrated transmission mechanism, a fluctuated energy input end, a split energy output end and a torque control end. A control method includes: providing the torque control end to control the controllably integrated transmission mechanism; connecting a fluctuated energy source or a speed-variable energy source to the fluctuated energy input end for inputting energy; according to a fluctuated energy input to the fluctuated energy input end, generating an energy buffer command or an energy split command via the torque control end to operate the controllably integrated transmission mechanism in an energy buffer state or an energy split state; according to the energy buffer state or the energy split state, controllably adjusting the input fluctuated energy in the controllably integrated transmission mechanism and thus outputting an adjusted energy via the split energy output end.

### BACKGROUND OF THE INVENTION

1. Field of the Invention

The present invention relates to an integrated transmission system and method thereof. More particularly, the present invention relates to the integrated transmission system and method thereof for controllably integrating and splitting an increase speed of a variable power input source.

2. Description of the Related Art

U.S. Pat. No. 6,387,004, entitled “Continuously Variable Transmission,” discloses a continuously variable transmission system, including a first planetary gear train and a second planetary gear train. The first planetary gear train and the second planetary gear train are used to correspondingly transmit powers, which are generated from a first motor and a second motor, to a transmission shaft.

However, the primary problem with such a transmission system is due to the fact that the powers generated from the first motor and the second motor must be constantly transmitted to the single transmission shaft via the first planetary gear train and the second planetary gear train. In this manner, the transmission shaft is fixedly designated as a single power input end while the first motor and the second motor are designated as two power input ends. The transmission system, however, cannot be functioned to variably control the power output. Hence, there is a need of providing an independently controllable transmission mechanism for variably controlling the power input, and for variably controlling the power output.

Another U.S. Pat. No. 8,585,530, entitled “Independently Controllable Transmission Mechanism,” discloses an independently controllable transmission mechanism, including a first planetary gear set, a second planetary gear set, a first transmission-connecting set and a second transmission-connecting set. The first planetary gear set includes a first power output end, the second planetary gear set includes a transmission control end, the first transmission-connecting set includes a first power input end and the second transmission-connecting set includes a free transmission end. The transmission control end controls the free transmission end to function as a second power input end or a second power output end.

Another U.S. Pat. No. 8,585,531, entitled “Independently Controllable Transmission Mechanism with an Identity-ratio Series Type,” discloses an independently controllable transmission mechanism, including a first planetary gear train and a second planetary gear train mechanically connected therewith. The transmission mechanism has a power output end, a transmission control end, a power input end and a free transmission end. The power output end and the transmission control end are provided on the first planetary gear train and the second planetary gear train, respectively. The power input end is provided on the first planetary gear train or the second planetary gear train while the free transmission end is provided on the second planetary gear train or the first planetary gear train. The transmission control end is operated to freely shift the free transmission end as a power input end or a power output end.

Another U.S. Pat. No. 8,585,532, entitled “Independently Controllable Transmission Mechanism with Series Types,” discloses an independently controllable transmission mechanism, including a first planetary gear train, a second planetary gear train, a first transmission-connecting set and a second transmission-connecting set. The first planetary gear train and the second planetary gear train are serially connected to form a series type. The independently controllable transmission mechanism has a first power output end, a transmission control end, a first power input end and a free-transmission end. The first power output end is provided on the first planetary gear train and the transmission control end is provided on the second planetary gear train. The first power input end is provided on the first transmission-connecting set and the free-transmission end is provided on the second transmission-connecting set. The transmission control end controls the free-transmission end to be functioned as a second power input end or a second power output end.

Another U.S. Pat. No. 8,585,533, entitled “Independently Controllable Transmission Mechanism with Simplified Parallel Types,” discloses an independently controllable transmission mechanism, including a first planetary gear train and a second planetary gear train. The first planetary gear train and the second planetary gear train are mechanically connected in parallel to form a parallel type. The controllable transmission mechanism has a first power output end, a transmission control end, a first power input end and a free-transmission end. The first power output end is provided on the first planetary gear train and the transmission control end is provided on the second planetary gear train. When the first power input end is provided on the first planetary gear train or the second planetary gear train, the free-transmission end is provided on the second planetary gear train or the first planetary gear train. The transmission control end controls the free-transmission end to be functioned as a second power input end or a second power output end.

Although the independently controllable transmission mechanisms disclosed in U.S. Pat. No. 8,585,530, U.S. Pat. No. 8,585,531, U.S. Pat. No. 8,585,532 and U.S. Pat. No. 8,585,533 are designed to improve the continuously variable transmission system disclosed in U.S. Pat. No. 6,387,004, there is a need of further providing an advanced function of integrated transmission, including controllably integrating and splitting an increase speed of a variable power input source, for example, to improve the useful function of the transmission system.

Another U.S. Pat. No. 8,187,130, entitled “Multi-speed Transmission with Integrated Electric Motor,” discloses a multiple speed transmission, including an input member, an output member, four planetary gear assemblies, each with first, second, and third members, a plurality of torque transmitting devices, an electric motor, and a switching device that selectively couples the electric motor to the input member and selectively couples the electric motor to one of the members of one of the planetary gear assemblies. The electric motor can be employed for regenerative braking. Further, the electric motor can be employed to launch and drive the motor vehicle with each of the gear ratios of the multi-speed transmission.

Another U.S. Pat. No. 8,602,934, entitled “Multi-speed Transmission with an Integrated Electric Motor,” discloses a multiple speed transmission, including an input member connected to an electric motor, an output member, four planetary gear assemblies, each with first, second, and third members, and a plurality of torque transmitting devices, such as, brakes and clutches. The electric motor can be employed for regenerative braking. Further, the electric motor can be employed to launch and drive the motor vehicle with each of the gear ratios of the multi-speed transmission.

Another U.S. Patent Application No. 2013/0260935, entitled “Multi-speed Transmission with an Integrated Electric Motor,” discloses a multiple speed transmission, including an input member, an output member, at least four planetary gear sets, a plurality of coupling members and a plurality of torque transmitting devices. Each of the planetary gear sets includes first, second and third members. The torque transmitting devices include clutches and brakes actuatable in combinations of three to establish a plurality of forward gear ratios and at least one reverse gear ratio.

Although the multiple speed transmissions disclosed in U.S. Pat. No. 8,187,130, U.S. Pat. No. 8,602,934 and U.S. Patent Application No. 2013/0260935 provide the torque transmitting device for regenerating braking energy which is integrated by the forward gear ratios and the reverse gear ratio for further outputting, there is a need of further providing an advanced function of integrated transmission, including controllably integrating and splitting an increase speed of a variable power input source, for example, to improve the useful function of the multiple speed transmission.

The above-mentioned patents and publications are incorporated herein by reference for purposes including, but not limited to, indicating the background of the present invention and illustrating the state of the art.

As is described in greater detail below, the present invention provides an integrated transmission system and method thereof utilizing a torque adjustment control end to connect with a controllably integrated transmission mechanism. The controllably integrated transmission mechanism further connects with a fluctuant power input end (or fluctuant power or energy source) and a split power output end. The torque adjustment control end is provided to control the controllably integrated transmission mechanism such that fluctuant power supplied from the fluctuant power input end is integrated in the controllably integrated transmission mechanism and is further transmitted the integrated power to the split power output end. The integrated transmission system and method of the present invention can achieve increasing the efficiency of power conversion and transmission.

### SUMMARY OF THE INVENTION

The primary objective of this invention is to provide an integrated transmission system and method thereof. A torque adjustment control end connects with a controllably integrated transmission mechanism which further connects with a fluctuant power input end (or fluctuant power or energy source) and a split power output end. The torque adjustment control end is provided to control the controllably integrated transmission mechanism such that fluctuant power supplied from the fluctuant power input end is integrated in the controllably integrated transmission mechanism and is further transmitted the integrated power to the split power output end. Accordingly, the integrated transmission system and method of the present invention is successful in increasing the efficiency of power conversion and transmission.

The integrated transmission system in accordance with an aspect of the present invention includes:

a controllably integrated transmission mechanism including a first side and a second side;

a fluctuant power input end provided on the first side of the controllably integrated transmission mechanism, with the fluctuant power input end connecting with a fluctuant power source or a speed variable power source;

a split power output end provided on the second side of the controllably integrated transmission mechanism, with the split power output end supplying an integrated transmission power; and

a torque adjustment control end connecting with the controllably integrated transmission mechanism for controlling power transmission;

wherein the fluctuant power source or the speed variable power source supplies fluctuant power to the integrated transmission system via the fluctuant power input end and a control command according to the fluctuant power is further sent to control the integrated transmission system via the torque adjustment control end such that the fluctuant power supplied from the fluctuant power input end is integrated in the controllably integrated transmission mechanism and is further transmitted an integrated power to the split power output end.

In a separate aspect of the present invention, the torque adjustment control end includes a servo motor.

In a further separate aspect of the present invention, the fluctuant power source or the speed variable power source includes a wind turbine, an incinerator, an ocean power generator, a hybrid electric vehicle, a hybrid power bicycle, a hybrid power ship or a renewable power source.

In a yet further separate aspect of the present invention, the split power output end includes at least one prime power consumption end and at least one buffer power consumption end.

In a yet further separate aspect of the present invention, the prime power consumption end connects with a prime generator and the buffer power consumption end connects with a buffer generator.

The integrated transmission method in accordance with an aspect of the present invention includes:

providing a torque adjustment control end to controllably connect with a controllably integrated transmission mechanism which includes a fluctuant power input end and a split power output end;

providing a fluctuant power source or a speed variable power source to supply fluctuant power to the controllably integrated transmission mechanism via the fluctuant power input end;

generating a power buffer control command or a power split control command according to the fluctuant power for operating the controllably integrated transmission mechanism in a power buffer state or a power split and buffer state; and

supplying an integrated power controllably integrated in the controllably integrated transmission mechanism to the split power output end according to the power buffer state or the power split and buffer state.

In a separate aspect of the present invention, the power buffer state is a first power input increase stage or a second power input increase stage.

In a further separate aspect of the present invention, when the first power input increase stage is executed, the split power output end connects with a buffer power consumption end or a prime power consumption end so as to supply the integrated power to the buffer power consumption end or the prime power consumption end.

In a yet further separate aspect of the present invention, the power split and buffer state is a second power input increase stage.

In a yet further separate aspect of the present invention, when the second power input increase stage is executed, the split power output end connects with a buffer power consumption end and a prime power consumption end so as to supply the integrated power to the buffer power consumption end and the prime power consumption end.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of an integrated transmission system in accordance with a preferred embodiment of the present invention.

FIG. 2 is a block diagram of the integrated transmission system in accordance with the preferred embodiment of the present invention.

FIG. 3 is a block diagram of control stages of an integrated transmission method in accordance with a preferred embodiment of the present invention.

FIG. 4 is an internal schematic view of an independently controllable transmission mechanism applied in the integrated transmission system in accordance with the preferred embodiment of the present invention.

FIG. 5 is a chart illustrating rotational speeds of a rotor in relation to those of a buffer generator simulated in a wind turbine applied with the integrated transmission system in accordance with the preferred embodiment of the present invention.

FIG. 6 is a chart illustrating rotational speeds of a rotor in relation to those of a prime generator simulated in the wind turbine applied with the integrated transmission system in accordance with the preferred embodiment of the present invention.

FIG. 7 is a chart illustrating rotational speeds of a rotor in relation to power generated from the buffer generator simulated in the wind turbine applied with the integrated transmission system in accordance with the preferred embodiment of the present invention.

FIG. 8 is a chart illustrating rotational speeds of a rotor in relation to power generated from the prime generator simulated in the wind turbine applied with the integrated transmission system in accordance with the preferred embodiment of the present invention.

FIG. 9 is a chart comparing total power generated from the wind turbine in relation to rotational speeds of the rotor applied with the integrated transmission system in accordance with the preferred embodiment of the present invention with MY 1.5Se wind turbine manufactured by Mingyang Electric Group Co., Ltd., Guangtong, China.

FIG. 10 is a chart comparing total power generated from the wind turbine in relation to wind speeds applied with the integrated transmission system in accordance with the preferred embodiment of the present invention with MY 1.5Se wind turbine manufactured by Mingyang Electric Group Co., Ltd., Guangtong, China.

### DETAILED DESCRIPTION OF THE INVENTION

It is noted that an integrated transmission system and control or operational method thereof in accordance with the preferred embodiment of the present invention can be suitable for a wide variety of transmission gearboxes of transmission-related mechanisms connected with fluctuated energy sources (e.g., stand-alone power generators) and is also applicable to ocean power generators (e.g., tidal power generator, wave power generator or ocean current power generator), wind power generators, incinerators, hybrid electric vehicles, hybrid power bicycles or hybrid power boats, which are not limitative of the present invention.

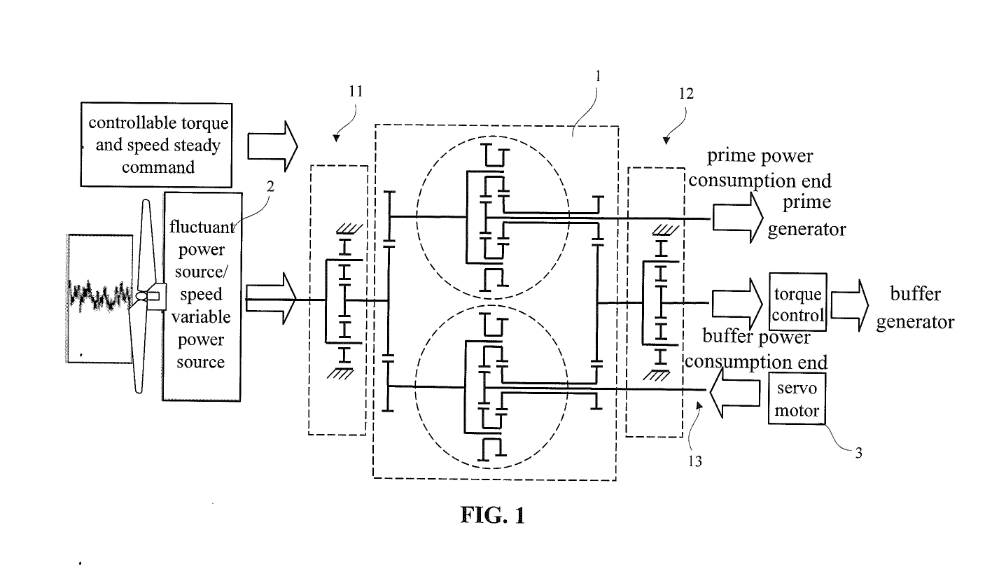

FIG. 1 shows a schematic view of an integrated transmission system in accordance with a preferred embodiment of the present invention. Referring now to FIG. 1, the integrated transmission system includes a controllably transmission mechanism 1, a fluctuant power input end 11, a split power output end 12 and a torque adjustment control end 13. The fluctuant power input end 11, the split power output end 12 and the torque adjustment control end 13 are appropriately provided on the controllably transmission mechanism 1.

FIG. 2 shows a block diagram of the integrated transmission system in accordance with the preferred embodiment of the present invention, corresponding to the integrated transmission system shown in FIG. 1. Referring to FIGS. 1 and 2, the controllably integrated transmission mechanism 1 includes a first side (shown at left side in FIG. 1) and a second side (shown at right side in FIG. 1). In an alternative embodiment, the first side and the second side are provided on other suitable positions of the controllably integrated transmission mechanism 1, including adjacent side positions. The controllably integrated transmission mechanism 1 provides several operational functions of speed increase, speed steady and speed split (or energy split). Furthermore, the operational functions of speed steady and speed split are integrated in power conversion and transmission, as best shown in FIG. 2.

With continued reference to FIGS. 1 and 2, by way of example, when the function of speed increase of the controllably integrated transmission mechanism 1 is applied to a wind power generator system, a low rotational speed of a rotor is appropriately converted into a higher rotational speed which is suitable for operating a generator. The rotational speed output must be maintained at a steady speed so as to supply a stable power from the generator. Once the rotational speed of the rotor reaches a predetermined speed corresponding to a normal rated power, a prime generator is operated to generate a normal rated power. When an increase of the wind speed increases the rotational speed of the rotor, the prime generator is still operated to generate the normal rated power and the remainder power of the increase of the wind speed is further split in the controllably integrated transmission mechanism 1 to transmit to a buffer generator (or another generator) for buffer power generation. Advantageously, the wind turbine system can avoid damages caused by suddenly strong wind to ensure operational safety. In addition, the buffer power generator can utilize the remainder power of the increase of the wind speed to generate additional increase power and the wind turbine system can widen an applicable range of wind speeds.

With continued reference to FIGS. 1 and 2, by way of example, the fluctuant power input end 11 is provided on the first side of the controllably integrated transmission mechanism 1 and the fluctuant power input end 11 mechanically connects with a fluctuant power source 2 (or speed variable power source). The fluctuant power input end 11 has a rotary shaft provided to transmit various increase stages of rotational speeds to the controllably integrated transmission mechanism 1.

With continued reference to FIGS. 1 and 2, by way of example, the fluctuant power source 2 (or speed variable power source) includes a wind turbine, an incinerator, an ocean power generator, a hybrid electric vehicle, a hybrid power bicycle, a hybrid power boat or other renewable power supply sources. According to types of the fluctuant power source 2, the controllably integrated transmission mechanism 1 is designed to provide two-stage or multi-stage speed increase control.

With continued reference to FIGS. 1 and 2, by way of example, the split power output end 12 is provided on the second side of the controllably integrated transmission mechanism 1 and the split power output end 12 is provided to mechanically transmit the split power. Accordingly, the power inputting into the fluctuant power input end 11 is buffered or integrated to split in the controllably integrated transmission mechanism 1, thereby supplying the split power to the exterior or other power facilities.

With continued reference to FIGS. 1 and 2, by way of example, the split power output end 12 mechanically connects with at least one prime power consumption end and at least one buffer power consumption end. The prime power consumption end connects with at least one prime generator or the like while the buffer power consumption end connects with at least one buffer generator or the like.

With continued reference to FIGS. 1 and 2, by way of example, the torque adjustment control end 13 connects with the controllably integrated transmission mechanism 1 for controlling it in operation. The torque adjustment control end 13 is provided to supply a torque adjustment and steady command to the controllably integrated transmission mechanism 1. Furthermore, the torque adjustment control end 13 includes a servo motor or the like which is selectively operated or stops according to the torque adjustment and steady command. Advantageously, the integrated transmission system provides several options of power output, including a first power output option of the prime power consumption end, a second power output option of the buffer power consumption end and a third power output option of the combination of the prime power consumption end and the buffer power consumption end.

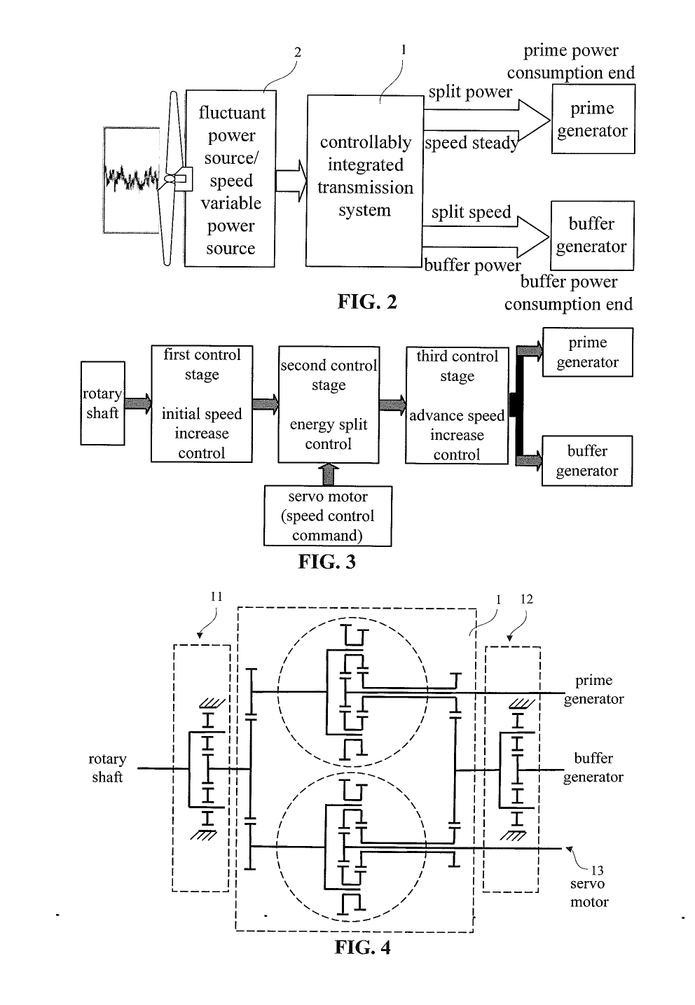

FIG. 3 shows a block diagram of three control stages of an integrated transmission method in accordance with a preferred embodiment of the present invention applied in the integrated transmission system shown in FIGS. 1 and 2. Referring now to FIGS. 1 to 3, by way of example, according to the speed increase of the rotary shaft of the fluctuant power input end 11, the controllably integrated transmission mechanism 1 provides a first transmission control stage, a second transmission control stage and a third transmission control stage. In control operation, the first transmission control stage is provided for initial speed increase, the second transmission control stage is provided for energy split and the third transmission control stage is provided for advanced speed increase.

FIG. 4 shows an internal schematic view of an independently controllable transmission mechanism applied in the integrated transmission system in accordance with the preferred embodiment of the present invention shown in FIGS. 1 and 2. Referring again to FIGS. 1, 2 and 4, the independently controllable transmission mechanism 1 includes a first planetary gear train, a second planetary gear train, a first transmission-connecting set and a second transmission-connecting set which are appropriately connected to form the controllably power integrated transmission system. Furthermore, an end of the fluctuant power input end 11 mechanically connects with the rotary shaft (shown at left side in FIG. 4) which further connects with the fluctuant power source 2 (or speed variable power source). The prime power consumption end of the split power output end 12 mechanically connects with the prime generator (shown at upper portion of right side in FIG. 4) while the buffer power consumption end of the split power output end 12 mechanically connects with the buffer generator (shown at middle portion of right side in FIG. 4). An end of the torque adjustment control end 13 mechanically connects with the servo motor (shown at lower portion of right side in FIG. 4).

Referring again to FIGS. 1 to 4, the integrated transmission method includes the step of: providing the torque adjustment control end 13 to controllably connect with the controllably integrated transmission mechanism 1. The servo motor or the like provided in the torque adjustment control end 13 is selectively operated to control the torque in the controllably integrated transmission mechanism 1, thereby providing the operational functions of speed increase or speed split (or energy split).

With continued reference to FIGS. 1 to 4, the integrated transmission method includes the step of: providing the fluctuant power source 2 (or speed variable power source) to supply fluctuant power to the controllably integrated transmission mechanism 1 via the fluctuant power input end 11 so as to widen the scope of rotational speeds or input energy supplied to the controllably integrated transmission mechanism 1. By way of example, when the fluctuant power source 2 is selected from a wind power generator system or an ocean power generator system, there is a need of converting a relatively low rotational speed of a large-sized windmill (or impeller) generated by various wind speeds, tide, waves or ocean currents into a relatively high rotational speed suitable for a generator.

With continued reference to FIGS. 1 to 4, the integrated transmission method includes the step of: according to the fluctuant power input of the fluctuant power input end 11 from the fluctuant power source 2, automatically or semi-automatically generating a power buffer control command or a power split control command to output to the torque adjustment control end 13 for operating the controllably integrated transmission mechanism 1 in a power buffer state, a power split and buffer state or other operational states.

With continued reference to FIGS. 1 to 4, the integrated transmission method includes the step of: according to the power buffer state, the power split and buffer state or other operational states, supplying an integrated power controllably integrated in the controllably integrated transmission mechanism 1 and converted from the fluctuant power of the fluctuant power input end 11 to the split power output end 12. Advantageously, the controllably integrated transmission mechanism 1 is successful in providing integrating and splitting power.

With continued reference to FIGS. 1 to 4, by way of example, the power buffer state corresponds to a first power input increase stage when the wind speeds or ocean current speeds increase. In the first power input increase stage, the split power output end 12 connects with the buffer power consumption end, thereby supplying the power to the buffer power consumption end. The power split and buffer state corresponds to a second power input increase stage. In the second power input increase stage, the split power output end 12 connects with the prime power consumption end and the buffer power consumption end, thereby supplying the power to the prime power consumption end and further supplying the power to the buffer power consumption end.

With continued reference to FIGS. 1 to 4, by way of example, the controllably integrated transmission mechanism 1 is applied in the wind power generator system. When a start-up wind speed (e.g. at least 3 m/s or other predetermined wind speeds) rotates a rotor (rotary shaft) of the wind power generator system, the rotational speeds of the rotor of the wind power generator system are set two or more rotational speed stages, according to the design needs, so as to output the power via the prime power consumption end and the buffer power consumption end.

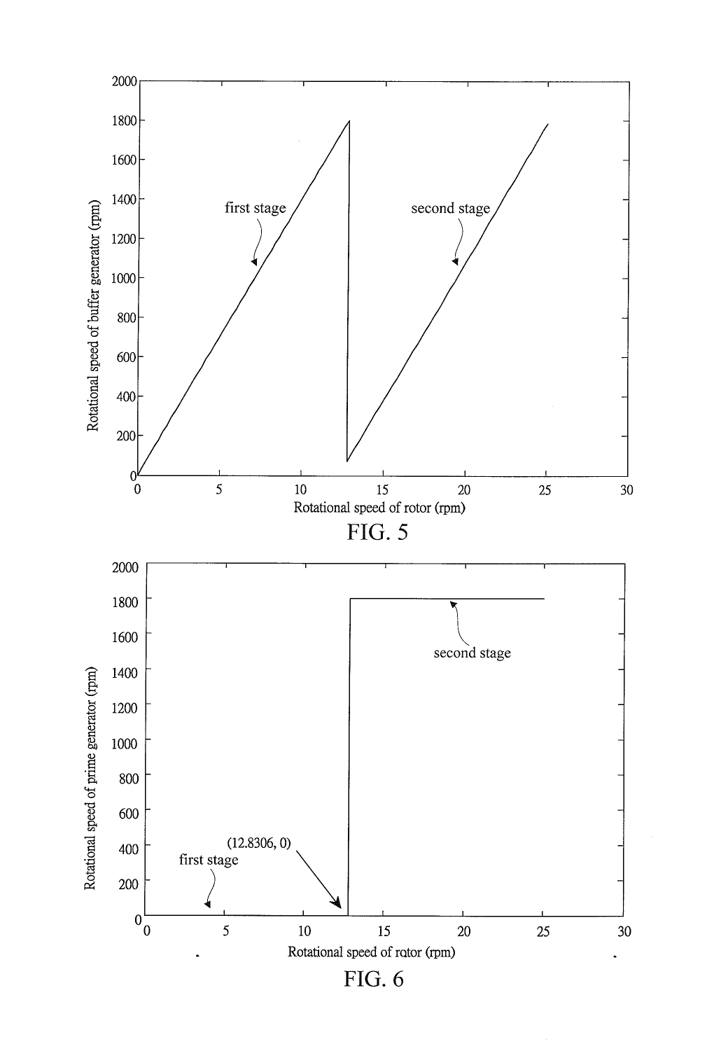

FIG. 5 shows a chart illustrating rotational speeds of a rotor in relation to those of a buffer generator simulated in a wind turbine applied with the integrated transmission system in accordance with the preferred embodiment of the present invention, including two rotational speed stages. FIG. 6 shows a chart illustrating rotational speeds of a rotor in relation to those of a prime generator simulated in the wind turbine applied with the integrated transmission system in accordance with the preferred embodiment of the present invention, comparing with FIG. 5. Turning now to FIGS. 5 and 6, in the first rotational speed stage (hereinafter identified as first stage), the rotational speeds of the rotor of the controllably integrated transmission mechanism 1 is 0≦n_{Rotor}≦12.8306 rpm and in the second rotational speed stage (hereinafter identified as second stage), the rotational speeds of the rotor of the controllably integrated transmission mechanism 1 is 12.8306 rpm≦n_{Rotor}≦25 rpm.

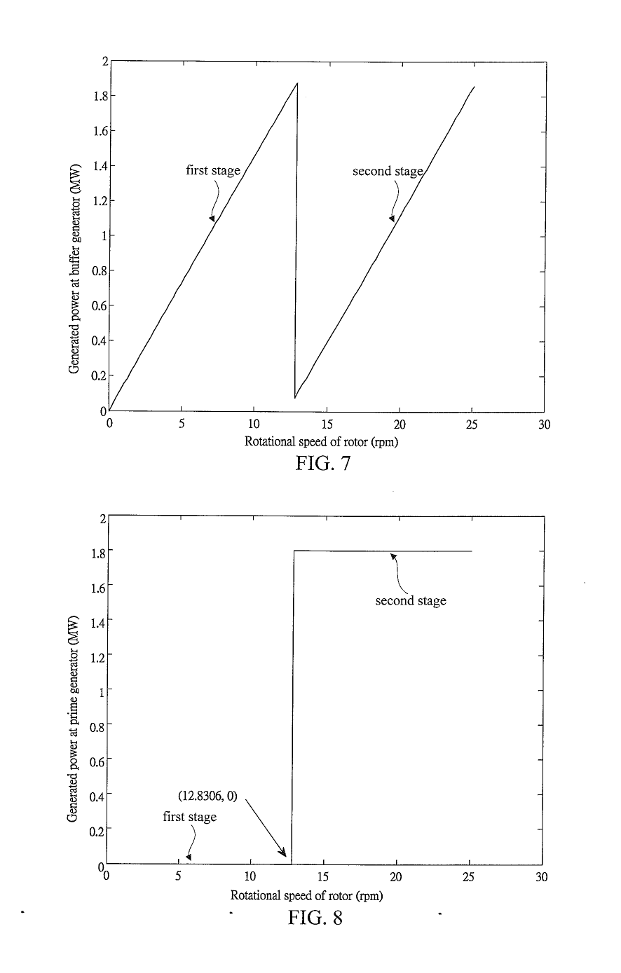

FIG. 7 shows a chart illustrating rotational speeds of a rotor in relation to power generated from the buffer generator simulated in the wind turbine applied with the integrated transmission system in accordance with the preferred embodiment of the present invention, corresponding to FIG. 5. FIG. 8 shows a chart illustrating rotational speeds of a rotor in relation to power generated from the prime generator simulated in the wind turbine applied with the integrated transmission system in accordance with the preferred embodiment of the present invention, corresponding to FIG. 6. Referring now to FIGS. 5 to 8, in the first stage, the rotational speed of the rotor of the controllably integrated transmission mechanism 1 ranges between 0 rpm and 12.8306 rpm. In this circumstance, the wind power generator system only allows operating the buffer generator while standing by the prime generator. The simulation results of the rotational speeds and power of the rotor in relation to those of the prime generator and the buffer generator are shown in left portions of FIGS. 5 to 8.

With continued reference to FIGS. 5 to 8, in the second stage, the rotational speed of the rotor of the controllably integrated transmission mechanism 1 is over 12.8306 rpm. In this circumstance, the wind power generator system only allows starting to operate the prime generator with a rated rotational speed 1,800 rpm for power generation and stopping the buffer generator as a stand-by generator. The simulation results of the rotational speeds and power of the rotor in relation to those of the prime generator and the buffer generator are best shown in middle portions of FIGS. 5 to 8.

With continued reference to FIGS. 5 to 8, in the second stage, when the rotational speed of the rotor of the controllably integrated transmission mechanism 1 is over 12.8306 rpm, the major power in the first stage is distributed to the prime generator for generating a rated power 1.8 MW. Once the buffer generator fails, the prime generator is allowably operated to generate power with the rated power. Conversely, once the prime generator fails, the buffer generator is allowably operated with a highest rotational speed.

With continued reference to FIGS. 5 to 8, in the second stage, when the rotational speed of the rotor of the controllably integrated transmission mechanism 1 ranges between 12.8306 rpm and 25 rpm, the wind power generator system allows operating the prime generator and the buffer generator. The simulation results of the rotational speeds and power of the rotor in relation to those of the prime generator and the buffer generator are best shown in right portions of FIGS. 5 to 8.

Referring now to right portions of FIGS. 5 to 8, in the second stage, when the rotational speed of the rotor of the controllably integrated transmission mechanism 1 is over 12.8306 rpm, the rotational speed of the prime generator is controllably maintained at the rated speed 1,800 rpm for generating stable power. In addition, the rotational speed of the buffer generator increases due to a continuous increase of the rotational speed of the rotor of the controllably integrated transmission mechanism 1 for generating additional power.

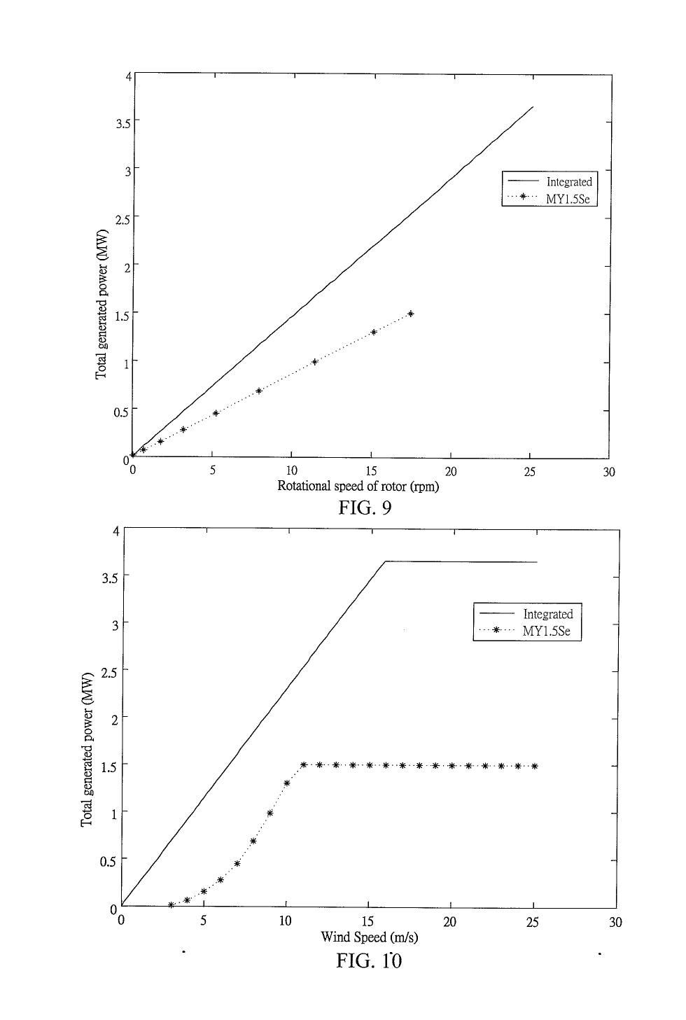

FIG. 9 shows a chart comparing total power generated from the wind turbine in relation to rotational speeds of the rotor applied with the integrated transmission system in accordance with the preferred embodiment of the present invention with MY 1.5Se wind turbine manufactured by Mingyang Electric Group Co., Ltd., Guangtong, China. FIG. 10 shows a chart comparing total power generated from the wind turbine in relation to wind speeds applied with the integrated transmission system in accordance with the preferred embodiment of the present invention with MY 1.5Se wind turbine manufactured by Mingyang Electric Group Co., Ltd., Guangtong, China. Referring to FIGS. 9 and 10, the data of MY 1.5Se wind turbine available in the website (www.mingyang.com.cn) of Mingyang Electric Group Co., Ltd., Guangtong, China (dotted lines shown in lower charts of FIGS. 9 and 10) is lower than the simulated rotational speeds of the rotor and simulated wind speeds in relation to total power of the wind turbine (lines shown in upper charts of FIGS. 9 and 10).

With continued reference to FIGS. 9 and 10, when the gear box of MY 1.5Se wind turbine has a speed increase ratio of 103.4483, the rated rotational speed of MY 1.5Se wind turbine is 1,800 rpm and the rated power generated from MY 1.5Se wind turbine is 1.5 MW. If the rated power generated from MY 1.5Se wind turbine changes to 3.6 MW with a ratio of equality, the rated torque of loading of MY 1.5Se wind turbine is about 3.6 MW/1800 rpm=19.0986 kNm and the start torque of loading of MY 1.5Se wind turbine becomes about 19.0986 kNm×103.4483. If the speed increase ratio of the gear box of MY 1.5Se wind turbine changes to 140, the start torque of loading of MY 1.5Se wind turbine becomes about 19.0986 kNm×140=2,673.8040 kNm.

With continued reference to FIGS. 9 and 10, when the operational functions of speed increase, speed steady and speed split of the controllably integrated transmission mechanism 1 are compared with the data of MY 1.5Se wind turbine, the efficiency of power generation of the present invention is higher than that of MY 1.5Se wind turbine. As best shown in upper lines in FIGS. 9 and 10, it is found that the speed increase ratio of the buffer generator to the rotor is 140.29, the rated torques of loading of the buffer generator and the prime generator are 9.9590 kNm and 9.5493 kNm respectively, and the start torque of loading of the rotor is 1,397.1484 kNm. In comparing MY 1.5Se wind turbine with the present invention, the start torque of loading of the rotor of the present invention relatively reduces

(2,673.8040−1,397.1484)/2,673.8040=47.75%.

Advantageously, total power generated from the wind turbine in relation to rotational speeds of the rotor and wind speeds applied with the integrated transmission system of the present invention is much greater than those of MY 1.5Se wind turbine.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An integrated transmission system comprising:
a controllably integrated transmission mechanism including a first side and a second side;
a fluctuant power input end provided on the first side of the controllably integrated transmission mechanism, with the fluctuant power input end connecting with a fluctuant power source or a speed variable power source;
a split power output end provided on the second side of the controllably integrated transmission mechanism, with the split power output end supplying an integrated transmission power; and
a torque adjustment control end connecting with the controllably integrated transmission mechanism for controlling power transmission;
wherein the fluctuant power source or the speed variable power source supplies fluctuant power to the integrated transmission system via the fluctuant power input end and a control command according to the fluctuant power is further sent to control the integrated transmission system via the torque adjustment control end such that the fluctuant power supplied from the fluctuant power input end is integrated in the controllably integrated transmission mechanism and is further transmitted an integrated power to the split power output end.

2. The integrated transmission system as defined in claim 1, wherein the torque adjustment control end includes a servo motor.

3. The integrated transmission system as defined in claim 1, wherein the fluctuant power source or the speed variable power source includes a wind turbine, an incinerator, an ocean power generator, a hybrid electric vehicle, a hybrid power bicycle, a hybrid power ship or a renewable power source.

4. The integrated transmission system as defined in claim 1, wherein the split power output end includes at least one prime power consumption end and at least one buffer power consumption end.

5. The integrated transmission system as defined in claim 1, wherein the prime power consumption end connects with a prime generator and the buffer power consumption end connects with a buffer generator.

6. An integrated transmission method comprising:
providing a torque adjustment control end to controllably connect with a controllably integrated transmission mechanism which includes a fluctuant power input end and a split power output end;
providing a fluctuant power source or a speed variable power source to supply fluctuant power to the controllably integrated transmission mechanism via the fluctuant power input end;
generating a power buffer control command or a power split control command according to the fluctuant power for operating the controllably integrated transmission mechanism in a power buffer state or a power split and buffer state; and
supplying an integrated power controllably integrated in the controllably integrated transmission mechanism to the split power output end according to the power buffer state or the power split and buffer state.

7. The integrated transmission method as defined in claim 6, wherein the power buffer state is a first power input increase stage or a second power input increase stage.

8. The integrated transmission method as defined in claim 6, wherein when the first power input increase stage is executed, the split power output end connects with a buffer power consumption end to supply the integrated power to the buffer power consumption end.

9. The integrated transmission method as defined in claim 6, wherein when the first power input increase stage is executed, the split power output end connects with a prime power consumption end to supply the integrated power to the prime power consumption end.

10. The integrated transmission method as defined in claim 6, wherein the power split and buffer state is a second power input increase stage.

11. The integrated transmission method as defined in claim 6, wherein when the second power input increase stage is executed, the split power output end connects with a buffer power consumption end to supply the integrated power thereto and further connects with a prime power consumption end to supply the integrated power thereto.

12. The integrated transmission method as defined in claim 6, wherein when the second power input increase stage is executed, the split power output end connects with a buffer power consumption end to supply the integrated power thereto.

13. The integrated transmission method as defined in claim 6, wherein when the second power input increase stage is executed, the split power output end connects with a prime power consumption end to supply the integrated power thereto.
